(19) United States
(12) Patent Application Publication
(10) Pub. No.: US 2006/0099438 A1
(43) Pub. Date: May 11, 2006

(54) Metal plating structure and method for production thereof

(76) Inventors: Susumu Arai, Nagano (JP); Morinobu Endo, Nagano (JP)

Correspondence Address: BIRCH STEWART KOLASCH & BIRCH, PO BOX 747, FALLS CHURCH, VA, 22040-0747, US

(21) Appl. No.: 10/532,940

(22) PCT Filed: Oct. 29, 2003
(86) PCT No.: PCT/JP03/13893

§ 371 Date: Apr. 28, 2005

(30) Foreign Application Priority Data
Nov. 1, 2002 (JP) 2002-320407

(51) Int. Cl. B32B 15/04; B32B 15/00; C25D 15/00

(52) U.S. Cl. 428/615; 428/457; 205/109

(57) ABSTRACT

A metal plating structure, characterized in that it comprises a metal plating film and, incorporated therein, a fine carbon fiber of a derivative thereof, wherein the fine carbon fiber represents a carbon fiber having a diameter of approximately 200 nm or less and an aspect ratio of approximately 10 or more; the metal plating structure, which further comprises a resin material incorporated therein; and a method for producing the metal plating structure. Examples of the derivative include substances prepared by subjecting the fine carbon fiber to various chemical modifications and by fluorinating the fine carbon fiber. The metal plating structure can be suitably used for incorporating a fine carbon fiber of a derivative thereof into a metal at an ordinary temperature.

### FIELD OF TECHNOLOGY

The present invention relates to a plating structure and a method of producing the plating structure.

### BACKGROUND OF TECHNOLOGY

A fine carbon fiber (diameter: 200 nm or less, aspect ratio: 10 or more) called “carbon nano tube (CNT)” or “carbon nano fiber” is characterized by a basic skeleton of carbon (six-ring) arranged in an axial direction, and it will be used in broad fields of technology due to its high heat conductivity, high electric conductivity, high slidablity, high mechanical strength, etc., which are derived form said characteristic.

Various methods of producing the CNT has been known, but the most advantageous method for mass production is a vapor growth method (see “Carbon Nano Tube (Jan. 30, 2001)” authored by Kazuyoshi Tanaka, published by Kagaku Doujin Shuppan Co. Ltd., page 67-77).

For example, the fine carbon fibers are incorporated in a metal to form a composite material, which can be used for sliding parts, heat radiators, etc.

Conventionally, the composite material is produced by the steps of: adding fine carbon fibers into a molten metal; and agitating the molten metal to mix.

However, in the conventional method, it is very difficult to uniformly disperse the fine carbon fibers in the molten metal because specific gravity of the fine carbon fiber is widely different from that of the molten metal.

Further, heat load is great with respect to the fine carbon fibers and other substances, so some components cannot be mixed with the fine carbon fibers.

Thus, the present invention has been invented to solve the above described problems, and an object of the present invention is to provide a plating structure, in which fine carbon fibers or derivatives thereof can be incorporated in a metal at room temperature, and a method of producing the plating structure.

### DISCLOSURE OF THE INVENTION

The plating structure of the present invention comprises a plating film, in which fine carbon fibers or derivatives thereof are incorporated. The derivatives include substances prepared by subjecting the fine carbon fibers to various chemical modifications and by fluorinating the fine carbon fibers. Note that, the fine carbon fiber means a carbon fiber having a diameter of about 200 nm or less and an aspect ratio of about 10 or more.

The incorporation can be performed in a plating step, they can be incorporated at room temperature, so that heat load of the substances to be incorporated can be reduced. In the plating structure, the plating film may be made of a single metal, or a metal alloy.

In the plating structure, fine resin materials, which are formed into powders, fibers, etc., may be incorporated.

In the plating structure, the plating film may be formed by electrolytic plating or electroless plating.

In the plating structure, ends of the fine carbon fibers may project from a surface of the plating film. The plating structure can be used as an emitter for field emission.

In the plating structure, the derivatives may be fluorinated carbon fibers.

An electronic part may comprise cable patterns having the plating structure.

A mechanical part, e.g., fine gear, may have the plating structure.

A multilayer body may comprise: some plated layers having the plating structures; and other plated layers being plated with a different metal. With this structure, heat conductivity in a direction of piling the layers is different from that in an orthogonal direction (a direction parallel to each layer), so that the multilayered body can be used as an anisotropic heat conductor.

A heat radiator may comprise: a plurality of plated layers having the plating structures; and a plurality of plated layers being plated with a different metal, wherein two types of the plated layers are alternately layered, and edges of the plated layers plated with the different metal are removed by etching whereby a plurality of the plated layers having the plating structures are arranged parallel with separations.

The method of the present invention comprises the steps of: adding a dispersing agent and fine carbon fibers or derivatives thereof into a plating solution so as to disperse the fine carbon fibers or the derivatives in the plating solution; and plating a substrate in the plating solution so as to form a plating film, in which the fine carbon fibers or the derivatives are incorporated, on a surface of the substrate.

In the method, resin materials may be further dispersed in the plating solution so as to form a plating film, in which the resin materials and the fine carbon fibers or the derivatives are incorporated, on the surface of the substrate.

In the method, a cationic and/or nonionic surface acting agent (surfactant) may be used as the dispersing agent.

In the method, the dispersing agent may be polycarboxylic acid, e.g., polyacrylic acid, or salt thereof.

The plating solution may include a dispersing agent, which is polycarboxylic acid, e.g., polyacrylic acid, or salt thereof, so as to disperse fine carbon fibers therein.

### BRIEF DESCRIPTION OF THE DRAWINGS

FIG. 1 is an explanation view showing a principle of dispersing electroplating;

FIG. 2 is an explanation view of CNTs, whose ends project;

FIG. 3 is an explanation view of a photoresist pattern;

FIG. 4 is an explanation view of a state, in which a plating structure is formed in a concave section;

FIG. 5 is an explanation view of a state, in which the photoresist pattern is removed;

FIG. 6 is an explanation view of fine gears;

FIG. 7 is an explanation view of a state, in which a via is formed;

FIG. 8 is an explanation view of a multilayered cable patterns;

FIG. 9 is an explanation view of heat radiating fins;

FIG. 10 is an explanation view of a carbon fiber incorporated in a plating film;

FIG. 11(a) is a micrograph of a surface of a plating film, which is formed by electrolytic plating in an agitated Base Solution 1 with current density of 2 A/dm², taken by a scanning electron microscope (SEM); FIG. 11(a′) is an enlarged view thereof, FIG. 11(b) is a micrograph of a surface of a plating film, which is formed by electrolytic plating in a plating solution of Example 1 with current density of 2 A/dm², taken by the scanning electron microscope (SEM); FIG. 11(b′) is an enlarged view thereof, FIG. 11(c) is a micrograph of a surface of a plating film, which is formed by electrolytic plating in a plating solution of Example 2 with current density of 2 A/dm², taken by the scanning electron microscope (SEM); FIG. 1(c′) is an enlarged view thereof;

FIGS. 12(a) and (b) are enlarged views of FIG. 11(c′), whose rate of enlargement are different;

FIG. 13(a) is a micrograph of a surface of a plating film, which is formed by electrolytic plating in the agitated Base Solution 1 with current density of 5 A/dm², taken by the scanning electron microscope (SEM); FIG. 13(a′) is an enlarged view thereof; FIG. 13(b) is a micrograph of a surface of a plating film, which is formed by electrolytic plating in the plating solution of Example 1 with current density of 5 A/dm², taken by the scanning electron microscope (SEM); FIG. 13(b′) is an enlarged view thereof; FIG. 13(c) is a micrograph of a surface of a plating film, which is formed by electrolytic plating in plating the solution of Example 2 with current density of 5 A/dm², taken by the scanning electron microscope (SEM); FIG. 13(c′) is an enlarged view thereof;

FIGS. 14(a) and (b) are enlarged views of FIG. 13(c′), whose rate of enlargement are different;

FIG. 15(a) is a micrograph of a surface of a plating film, which is formed by electrolytic plating in the agitated Base Solution 1 with current density of 2 A/dm², taken by the scanning electron microscope (SEM); FIG. 15(a′) is an enlarged view thereof; FIG. 15(b) is a micrograph of a surface of a plating film, which is formed by electrolytic plating in a plating solution of Example 3 with current density of 2 A/dm², taken by the scanning electron microscope (SEM); FIG. 15(b′) is an enlarged view thereof; FIG. 15(c) is a micrograph of a surface of a plating film, which is formed by electrolytic plating in a plating solution of Example 4 with current density of 2 A/dm², taken by the scanning electron microscope (SEM); FIG. 15(c′) is an enlarged view thereof;

FIGS. 16(a) and (b) are enlarged views of FIG. 15(c′), whose rate of enlargement are different;

FIG. 17(a) is a micrograph of a surface of a plating film, which is formed by electrolytic plating in an agitated Base Solution 2 with current density of 2 A/dm², taken by the scanning electron microscope (SEM); FIG. 17(a′) is an enlarged view thereof; FIG. 17(b) is a micrograph of a surface of a plating film, which is formed by electrolytic plating in a plating solution of Example 5 with current density of 2 A/dm², taken by the scanning electron microscope (SEM); FIG. 17(b′) is an enlarged view thereof; FIG. 17(c) is a micrograph of a surface of a plating film, which is formed by electrolytic plating in a plating solution of Example 6 with current density of 2 A/dm², taken by the scanning electron microscope (SEM); FIG. 17(c′) is an enlarged view thereof;

FIG. 18(a) is a micrograph of a surface of a plating film, which is formed by electrolytic plating in the agitated Base Solution 2 with current density of 5 A/dm², taken by the scanning electron microscope (SEM); FIG. 18(a′) is an enlarged view thereof; FIG. 18(b) is a micrograph of a surface of a plating film, which is formed by electrolytic plating in the plating solution of Example 5 with current density of 5 A/dm², taken by the scanning electron microscope (SEM); FIG. 18(b′) is an enlarged view thereof; FIG. 18(c) is a micrograph of a surface of a plating film, which is formed by electrolytic plating in the plating solution of Example 6 with current density of 5 A/dm², taken by the scanning electron microscope (SEM); FIG. 18(c′) is an enlarged view thereof;

FIG. 19 is an enlarged view of FIG. 18(c′);

FIG. 20(a) is a micrograph of a surface of a plating film, which is formed by electrolytic plating in the agitated Base Solution 2 with current density of 2 A/dm², taken by the scanning electron microscope (SEM); FIG. 20(a′) is an enlarged view thereof; FIG. 20(b) is a micrograph of a surface of a plating film, which is formed by electrolytic plating in a plating solution of Example 7 with current density of 2 A/dm², taken by the scanning electron microscope (SEM); FIG. 20(b′) is an enlarged view thereof; FIG. 20(c) is a micrograph of a surface of a plating film, which is formed by electrolytic plating in a plating solution of Example 8 with current density of 2 A/dm², taken by the scanning electron microscope (SEM); FIG. 20(c′) is an enlarged view thereof, FIG. 21(a) is a micrograph of a surface of a plating film, which is formed by electrolytic plating in the agitated Base Solution 2 with current density of 5 A/dm², taken by the scanning electron microscope (SEM); FIG. 21(a′) is an enlarged view thereof; FIG. 21(b) is a micrograph of a surface of a plating film, which is formed by electrolytic plating in the plating solution of Example 7 with current density of 5 A/dm², taken by the scanning electron microscope (SEM); FIG. 21(b′) is an enlarged view thereof; FIG. 21(c) is a micrograph of a surface of a plating film, which is formed by electrolytic plating in the plating solution of Example 8 with current density of 5 A/dm², taken by the scanning electron microscope (SEM); FIG. 21(c′) is an enlarged view thereof, FIGS. 22(a) and (b) are enlarged views of FIG. 21(c′), whose rate of enlargement are different; and

FIG. 23 are micrographs of surfaces of plating films (a: surfaces of fine carbon fibers are not plated; b: surfaces of fine carbon fibers are plated by electroless plating in a solution of Example 9) taken by the scanning electron microscope (SEM).

### PREFERRED EMBODIMENTS OF THE INVENTION

Preferred embodiments of the present invention will now be described in detail with reference to the accompanying drawings.

In the present invention, a dispersing agent and fine carbon fibers or derivatives of the fine carbon fibers are added in a plating solution so as to disperse the fine carbon fibers or the derivatives thereof in the plating solution, then plating is performed so that a plating film, in which the fine carbon fibers or the derivatives thereof (hereinafter referred to as “fine carbon fibers, etc.” or merely referred to as “fine carbon fibers”) are incorporated in a plating metal, can be formed on a surface of a substrate.

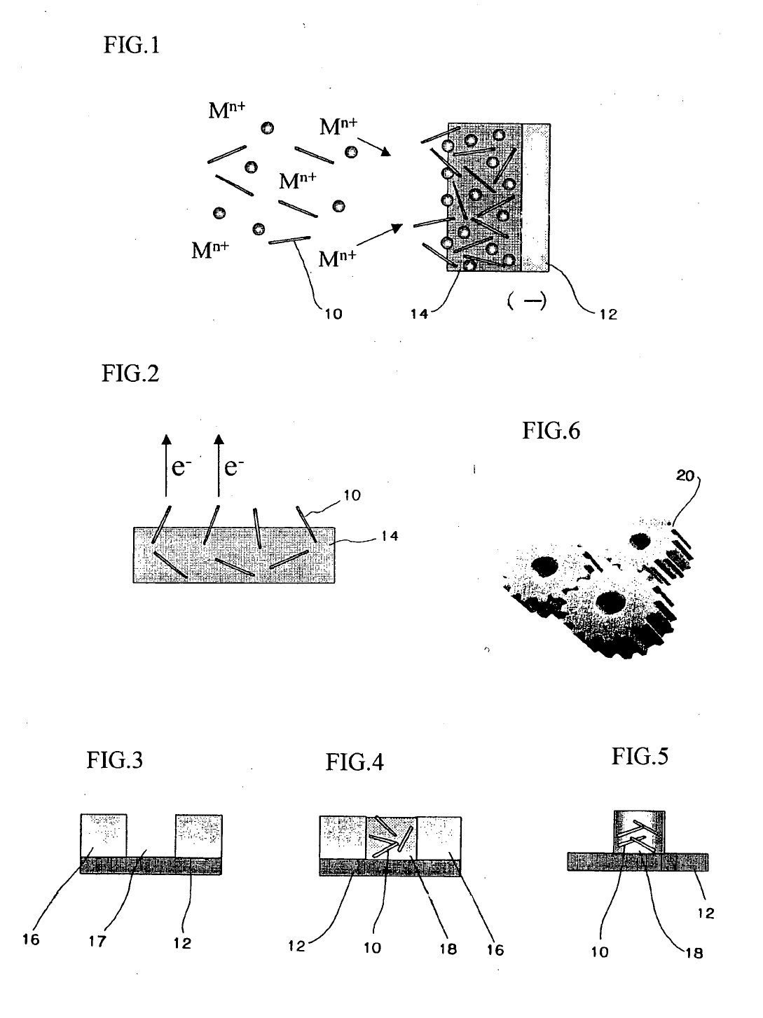

FIG. 1 is a schematic explanation view showing a principle of dispersing electroplating.

Fine carbon fibers 10, e.g., CNTs, or derivatives of fine carbon fibers are uniformly dispersed in a plating solution by a dispersing agent. Preferably, the plating solution is agitated during the plating process, so that the fine carbon fibers 10, etc. are capable of swimming in the plating solution without settling down.

In this state, when the plating metal deposits onto a surface of a substrate 12, the fine carbon fibers 10, etc., which locate on the surface of the substrate 12, are incorporated in a plating film 14 by electrolytic plating, so that a composite material (plating structure) of the metal and the fine carbon fibers, etc. is formed on the surface of the substrate 12.

Note that, the plating method is not limited to a direct current plating method, further a current inversion plating method, a pulse plating method, etc. may be employed.

The fine carbon fibers 10 has slight water repellency, and they are hard to be dispersed in the plating solution without the dispersing agent. Especially, fluorinated carbon fibers are very hard to be dispersed.

Thus, the dispersing agent is added to the plating solution so as to disperse the fine carbon fibers, etc. therein.

The dispersing agent is not limited, but cationic or nonionic surface acting agents (surfactant) can be used as preferred dispersing agents for electrolytic plating.

Preferred cationic surface acting agents are, for example, cetyltrimethylammonium chloride, cetyltrimethylammonium bromide, cetylpyridinium chloride.

To disperse fluorinated carbon fibers, cationic surface acting agents, e.g., N-[(3-perfluorooctanesulfonamide) propyl]-N,N,N,-trimethylammonium iodide, may be used.

Preferred anionic surface acting agents are, for example, sodium dedocyl sulfate, dodecanoic sodium, sodium tetradecylsulfate, fatty acid sodium, fatty triethanolamine salt, sodium alkylbenzenesulfate, sodium monoalkyl phosphate.

To disperse fluorinated carbon fibers, anionic surface acting agents, e.g., perfluorooctane sulfonic acid, perfluorooctane sulfonate, N-propyl-N-perfluorooctylsulfonyl glycine potassium salt, bis [2-(N-propyl perfluorooctylsulfonylamino)ethyl] ammonium phosphate, perfluorocaprylic acid, perfluorooctanoate ammonium, may be used.

Preferred nonionic surface acting agents are, for example, polyacrylic acid, polyethylene glycol, polyoxyethylene nonylphenyl ether, polyoxythylene dodecyl ether, polyoxyethylene lauryl ether, polyoxyethylene lauryl ether, polyoxyethylene fatty acidic ether, polyoxyethylene polyoxypropylene block polymer, polyoxyethylene alkylamine, alkylpolyglucoside, glycerin fatty acidic ester, sorbitan fatty acidic ester, saccharate fatty acidic ester, propylene glycol fatty acidic ester.

To disperse fluorinated carbon fibers, nonionic surface acting agents, e.g., N-Propyl-N-(2-hydroethyl) perfuorooctane sulfonate amide, N-polyoxyethylene-N-propylperfluorooctanesulfonate amide, N-(2-hydoroxyethylene)-N-perfluorooctylsulfonyl benzylamine, may be used.

The surface acting agents may be solely used or combined.

Further, polycarboxylic acid, e.g., polyacrylic acid, and salt thereof are suitable dispersing agents. Polyacrylic acid having molecular weight of about 3000-4000 has high uniform dispersibility.

The plating solution is not limited, but nickel plating solution and copper plating solution are suitable solutions.

Further, various alloy solutions may be used.

Plating may be performed by not only electrolytic plating but also electroless plating.

In the case of electroless plating too, when the plating metal deposits onto the surface of the substrate (plate) 12, the fine carbon fibers, etc. are incorporated in the plating film 14 as shown in FIG. 1.

Since the fine carbon fibers have high heat conductivity and high electric conductivity, the plating structures produced by above described methods also have high heat conductivity and high electric conductivity. Therefore, they may be widely used, e.g., heat sinks, electric elements.

As shown in FIG. 2, the fine carbon fibers 10 are fixed in the plating film 14, and their ends project from a surface of the plating film 14. Especially, the state shown in FIG. 2 is remarkable in the plating film 14 plated with copper.

The plating structure, in which the fine carbon fibers 10 are fixed in the plating film 14 and their ends project therefrom as shown in FIG. 2, is suitably used as an emitter for field emission.

Field emission from carbon nano tubes (CNTs) has been studied, and we pay attention to carbon nano tubes as a material of a display.

To realize the field emission, a strong electric field must be produced. Thus, the ends must be sharpened as a material of the emitter. In this regard, CNTs have the great aspect ratio and the sharp ends, and they are chemically stable, mechanically tough and highly stable at high temperature, namely they are suitable materials of the emitter for field emission.

Conventionally, CNTs have been used for a broad cold cathode of a light emitting device, in which a plurality of CNTs are fixed on a substrate and headed in the same direction by screen printing, etc.

However, it is difficult to fix a plurality of CNTs on the substrate with heading in the same direction by screen printing. On the other hand, in the plating method of the present embodiment, fine carbon fibers (CNTs) are vertically fixed in the plating film; therefore, the emitter for field emission, which has a plurality of emitting ends, can be easily produced.

FIGS. 3-5 show steps of producing a fine mechanical part.

In FIG. 3, a resist pattern 16 having a concave section 17 is formed on the substrate 12 by photolithography. Next, as shown in FIG. 4, a plating structure 18, in which the fine carbon fibers 10 are incorporated, is formed in the concave section 17, then the resist pattern 16 is removed as shown in FIG. 5, so that the pillar-shaped plating structure 18 is produced on the substrate 12. Next, the plating structure 18 is removed from the substrate 12, so that fine mechanical parts, e.g., very fine gears 20 shown in FIG. 6, can be produced. Since the plating structure 18 (20) includes the fine carbon fibers, it can be used as, for example, a pillar shaped part having high toughness and high durability.

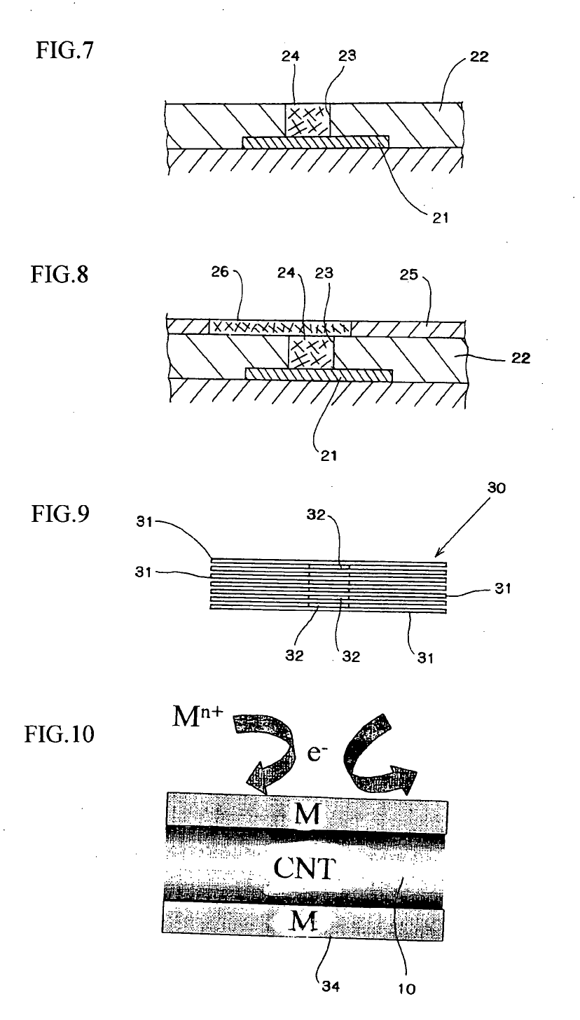

FIGS. 7 and 8 show steps of producing a multilayer circuit board, which is an example of electronic parts.

In FIG. 7, an insulating layer 22 is formed on a cable pattern 21 of a lower layer by, for example, applying insulating resin; next, a via hole 23, in which the cable pattern 21 is exposed, is formed in the insulating layer 22 by, for example, laser means; and a plating structure (via) 24, in which fine carbon fibers are incorporated, is formed in the via hole 23 by the above described plating method.

In FIG. 8, a resist pattern 25, in which the via 24 is exposed, is formed on the insulating layer 22 by photolithography, then a cable pattern 26, which is a plating structure including fine carbon fibers and which is electrically connected to the via 24, is formed by electroless plating and electrolytic plating (an additive method). By the above described steps, the multilayer circuit board, which has the cable patterns constituted by the plating structures including the fine carbon fibers, can be produced.

The cable pattern 26, which includes the fine carbon fibers, also has high electric conductivity.

Note that, the plating method is not limited to the additive method; for example, the plating film (the plating structure) may be entirely formed on the insulating layer by electroless plating and electrolytic plating, then the plating film may be etched so as to form the cable pattern (a subtractive method).

Note that, another embodiment, not shown, is a cable pattern connected to electrodes of a semiconductor chip, and the cable pattern may be produced by forming a polyimide resin layer (an insulating layer) on the semiconductor chip and forming the plating structure, which includes fine carbon fibers, thereon as the cable pattern. Bumps for connecting to an external circuit may be provided to proper positions so as to relocate the electrodes of the semiconductor chip.

The cable pattern for relocating the electrodes has not only high electric conductivity but also high heat conductivity; the cable pattern acts as a heat sink of the semiconductor chip, and heat radiation rate thereof can be improved.

FIG. 9 shows a heat radiator constituted by the plating structure.

Firstly, a plurality of plated layers 31, each of which is constituted by the plating structure including the fine carbon fibers (e.g., copper layer including CNTs), and a plurality of plated layers 32, each of which is made of a different metal (e.g., nickel) and each of which may include fine carbon fibers or no fine carbon fibers, are alternately piled. In the multilayer body, heat conductivity in a direction of piling the layers is different from that in an orthogonal direction (a direction parallel to each layer), so that the multilayered body can be used as an anisotropic heat conductor. Especially, if the plated layers 32 include no fine carbon fibers, heat conductivity of the plated layers 31 including the fine carbon fibers is greater, so that the multilayer body is suitably used as the anisotropic heat conductor. Note that, the plated layers of the multilayer body may be made of three different metals or more.

For example, if edges of the plated layers 32 are removed by etching, a plurality of the plated layers 31 constituted by the plated structure including the fine carbon fibers are arranged parallel with fine separations, so that a heat radiator 30 can be produced. The plated layers 31 have very high heat radiation rate, and total surface area of the plated layers 31, which are arranged parallel, is very large so that the heat radiator 30 has very high heat radiation rate.

Fluorinated carbon fibers are produced by fluorinating fine carbon fibers, e.g., CNTs.

For example, the fluorination is performed under the following conditions.

Namely, the fluorination is performed by the steps of: filling a nickel boat with fine carbon fibers (e.g., CNTs); setting in a nickel tube for fluorination; and reacting with fluorine for 72 hours at temperature of 340° C. with fluorine-partial pressure of 460 mmHg and nitrogen-partial pressure of 310 mmHg, so that fluorinated carbon fibers, each of which has a structure of Cₓ F_{y}, can be produced.

To accelerate the fluorination, a catalytic agent, e.g., silver fluoride, may be used.

The fluorinated carbon fibers have high water repellency.

The fluorinated carbon fibers are added to a plating solution together with a dispersing agent, as well as the former embodiment, so as to uniformly disperse in the plating solution, then plating is performed with agitating the plating solution; the fluorinated carbon fibers, which locate on the surface of the substrate 12, are incorporated in the plating film 14 when the plating metal deposits onto the surface of the substrate 12 as well as the embodiment shown in FIG. 1, so that a composite material (plating structure) of the metal and the fluorinated carbon fibers is formed on the surface of the substrate 12.

The composite material also has high water repellency.

If the plating is performed in the plating solution in which fine resin powders or fine resin fibers, e.g., fluorocarbon resin such as Teflon (trademark), is further dispersed, The fine resin powders or the fine resin fibers can be incorporated in the plating film together with the fluorinated carbon fibers. The composite material including the three substances also has high water repellency.

Note that, the composite material including three substances may include the above described fine carbon fibers instead of the fluorinated carbon fibers.

FIG. 10 shows the fine carbon fiber (CNT) 10, whose surface is coated with a plating film 34.

The plating films 34 are formed by dispersing CNTs in a plating solution for electroless plating with a dispersing agent and performing electroless plating. By dispersing the CNTs 10 in the plating solution, the electroless plating films 34 can be formed on surfaces of the CNTs 10 with uniform thickness.

The carbon fibers, whose surfaces are coated with the plating films, have great specific gravity, and they have high homology with metals; the carbon fibers can be uniformly dispersed in a molten metal, so that a composite material, in which the carbon fibers and the metal are well homogenized, can be produced. And, the carbon fibers may be dispersed in resin so as to produce a composite material including the resin. Further, the carbon fibers, whose surfaces are coated with the plating films, may be mixed with adhesive resin so as to produce electric conductive resin.

Experiments

(Base Solution 19

| | | |
|---|---|---|
| NiSO₄.6H₂O | 1 | M |
| NiCl₂.6H₂O | 0.2 | M |
| H₃BO₃ | 0.5 | M |

### EXAMPLE 1

| | |
|---|---|
| Base Solution 1 + PA5000 | 2 × 10⁻⁴ M |

(PA5000 was added to the Base Solution)

### EXAMPLE 2

| | |
|---|---|
| Base Solution 1 + PA5000 | 2 × 10⁻⁴ M |
| CNT | 2 g/l |

(Note that, PA5000 was polyacrylic acid, whose molecular weight was 5000)

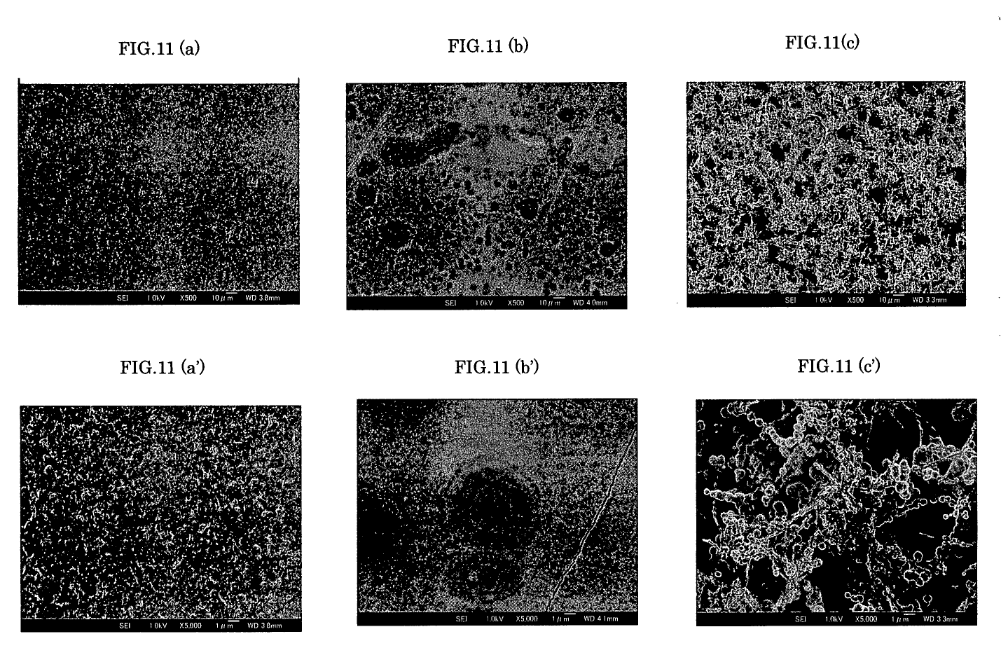

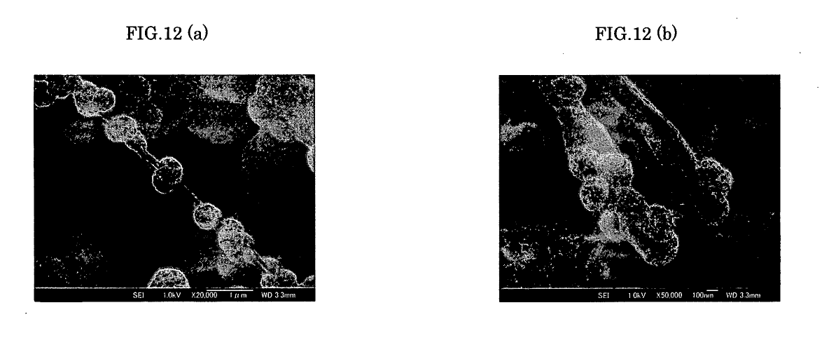

Plating films were respectively formed in the Base Solution 1 and the plating solutions of Examples 1 and 2, which were agitated while plating, by electrolytic plating with current density of 2 A/dm², and micrographs of their surfaces taken by a scanning electron microscope (SEM) are shown in FIGS. 11(a), (a′), FIGS. 11(b), (b′) and FIGS. 11(c), (c′) (note that, (a′), (b′) and (c′) are enlarged views of (a), (b) and (c). The relations in the following Examples are the same as here). FIGS. 12(a) and (b) are enlarged views of FIG. 11(c′), whose rate of enlargement are different.

As clearly shown in FIGS. 11(a) and 11(a′), a surface of a nickel plating film was relatively rough; as clearly shown in FIGS. 11(b) and 11(b′), flatness of the surface was improved and a lustered plating film was gained by adding polyacrylic acid. Polyacrylic acid acted as not only the agent for dispersing CNTs but also a brightening agent. As clearly shown in FIGS. 11(c) and 11(c′), the CNTs were incorporated in the nickel plating film. As clearly shown in FIGS. 11(c′) and 12, nickel grew on surfaces of the CNTs like particles and covered the CNTs, further the particles of nickel were joined each other, so that the CNTs were incorporated in the nickel plating film.

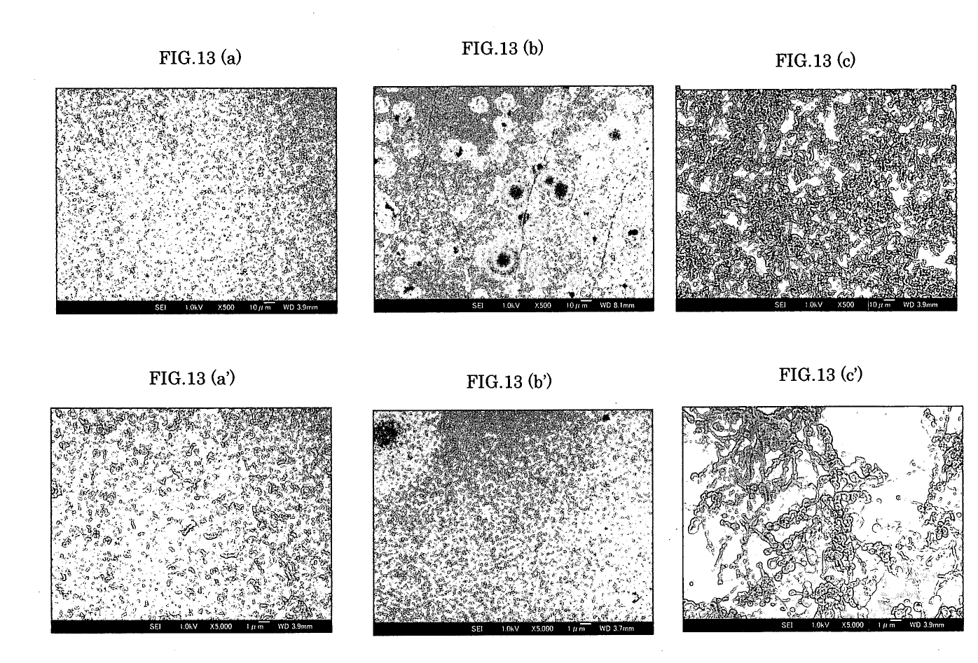

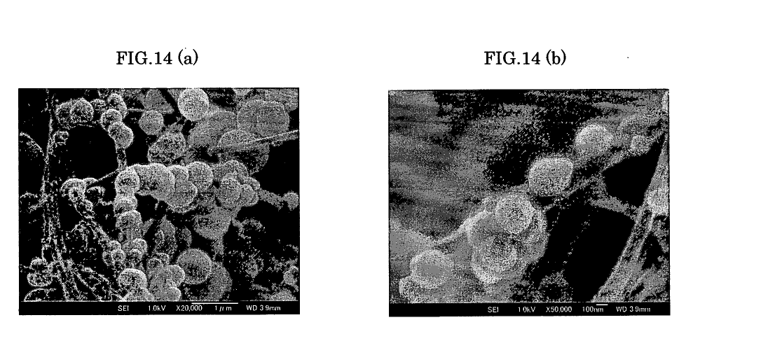

Other plating films were respectively formed in the Base Solution 1 and the plating solutions of Examples 1 and 2, which were agitated while plating, by electrolytic plating with current density of 5 A/dm², and micrographs of their surfaces taken by the scanning electron microscope (SEM) are shown in FIGS. 13(a), (a′), FIGS. 13(b), (b′) and FIGS. 13(c), (c′). FIGS. 14(a) and (b) are enlarged views of FIG. 13(c′), whose rate of enlargement are different. The current density was changed, but results were almost the same as those shown in FIG. 11.

### EXAMPLE 3

| | |
|---|---|
| Base Solution 1 + PA25000 | 2 × 10⁻⁴ M |

### EXAMPLE 4

| | |
|---|---|
| Base Solution 1 + PA25000 | 2 × 10⁻⁴ M |
| CNT | 2 g/l |

(Note that, PA25000 was polyacrylic acid, whose molecular weight was 25000)

In Examples 3 and 4, the molecular weight of polyacrylic acid was 25000, but other conditions were the same as those of Examples 1 and 2.

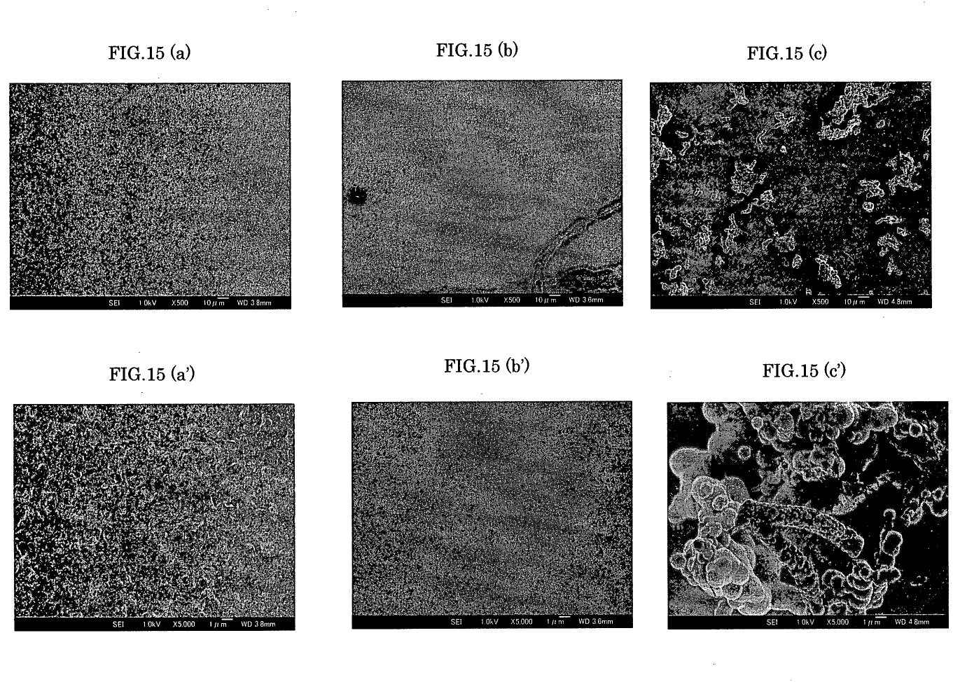

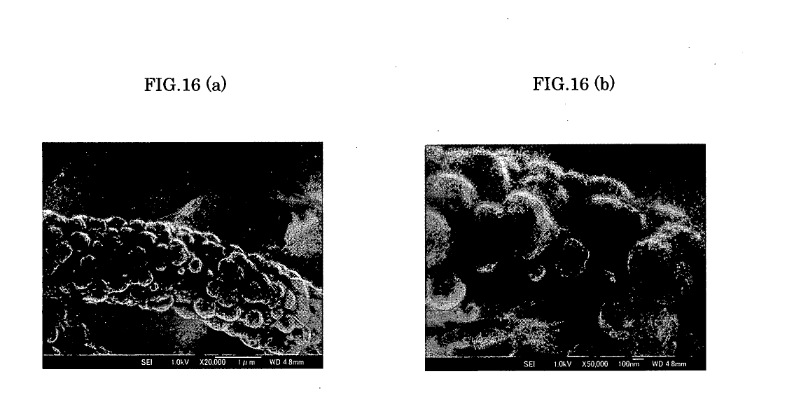

Plating films were respectively formed in the Base Solution 1 and the plating solutions of Examples 3 and 4, which were agitated while plating, by electrolytic plating with current density of 2 A/dm², and micrographs of their surfaces taken by the scanning electron microscope (SEM) are shown in FIGS. 15(a), (a′), FIGS. 15(b), (b′) and FIGS. 15(c), (c′). FIGS. 16(a) and (b) are enlarged views of FIG. 15(c′), whose rate of enlargement are different. The molecular weight of polyacrylic acid was 25000, but results were almost the same as those shown in FIG. 11.

Further, the current density was changed to 5 A/dm², but results were almost the same.

(Base Solution 2)

| | |
|---|---|
| CuSO₄.5H₂O | 0.85 M |
| H₂SO₄ | 0.55 M |

### EXAMPLE 5

| | |
|---|---|
| Base Solution 2 + PA5000 | 2 × 10⁻⁴ M |

### EXAMPLE 6

| | |
|---|---|
| Base Solution 2 + PA5000 | 2 × 10⁻⁴ M |
| CNT | 2 g/l |

(Note that, PA5000 was polyacrylic acid, whose molecular weight was 5000)

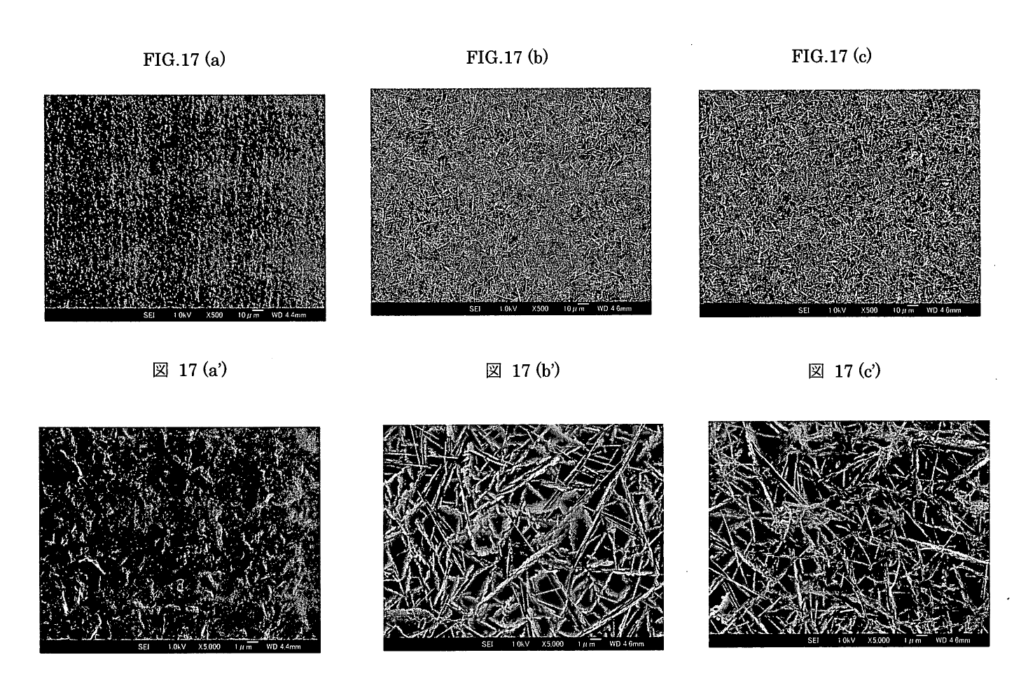

Plating films were respectively formed in the Base Solution 2 and the plating solutions of Examples 5 and 6, which were agitated while plating, by electrolytic plating with current density of 2 A/dm², and micrographs of their surfaces taken by the scanning electron microscope (SEM) are shown in FIGS. 17(a), (a′), FIGS. 17(b), (b′) and FIGS. 17(c), (c′).

As clearly shown in 17(b), (b′) and FIGS. 17(c), (c′), by adding polyacrylic acid and applying the current density of 2 A/dm², surfaces of the plating films were made rough, so the plating films were useless.

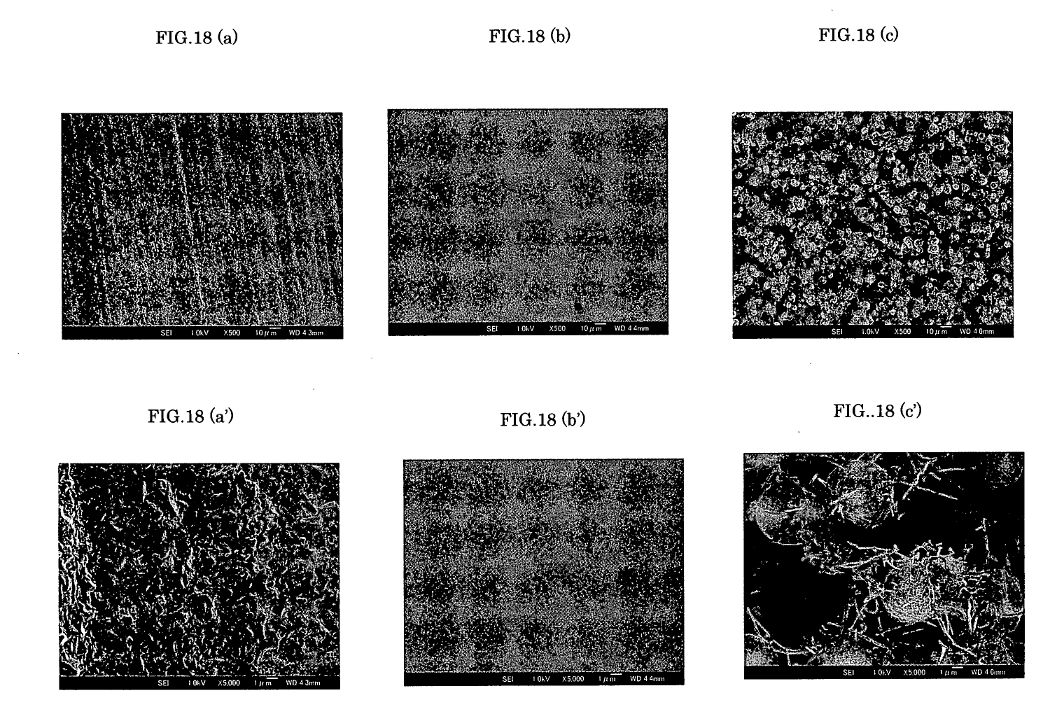

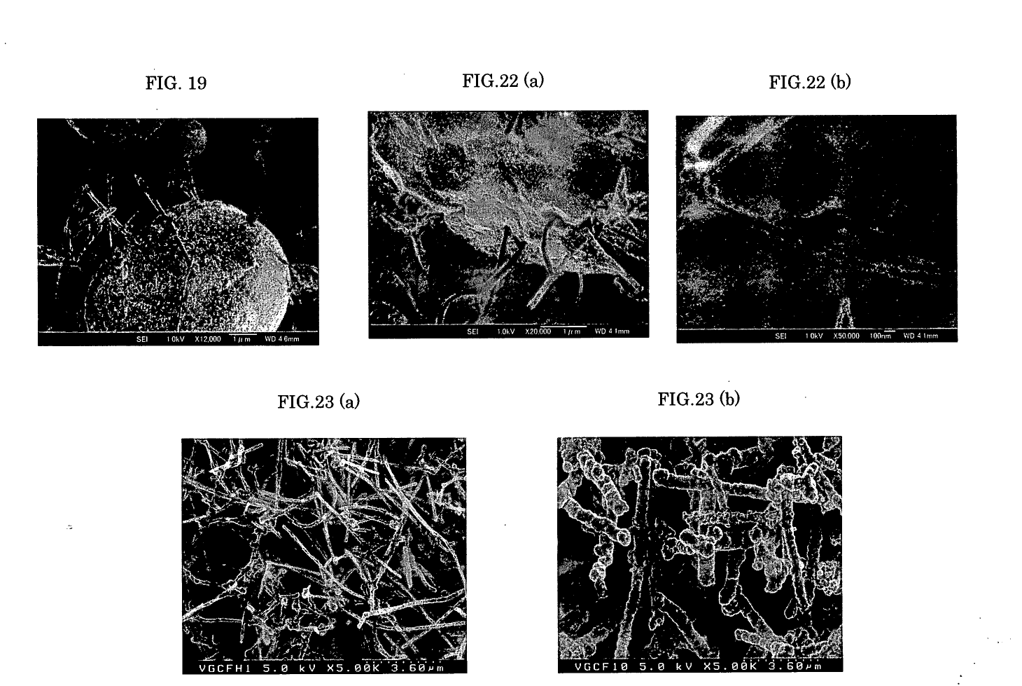

Other plating films were respectively formed in the Base Solution 2 and the plating solutions of Examples 5 and 6, which were agitated while plating, by electrolytic plating with current density of 5 A/dm², and micrographs of their surfaces taken by the scanning electron microscope (SEM) are shown in FIGS. 18(a), (a′), FIGS. 18(b), (b′) and FIGS. 18(c), (c′). FIG. 19 is an enlarged view of FIG. 18(c′). As clearly shown in FIGS. 18(a) and 18(a′), a surface of a copper plating film was rough; as clearly shown in FIGS. 18(b) and 18(b′), flatness of the surface can be improved and a lustered plating film was gained by adding polyacrylic acid and increasing the current density to 5 A/dm². Polyacrylic acid acted as not only the agent for dispersing CNTs but also a brightening agent. As clearly shown in FIGS. 18(c) and 18(c′), the CNTs were incorporated in the nickel plating film. Unlike nickel plating, in copper plating, a plating metal did not grow on surfaces of the CNTs like particles, and copper directly deposited on a substrate as shown in FIG. 19, so that the CNTs were incorporated in the deposited copper plating film and fixed therein. Further, as shown in FIG. 19, projecting ends of the CNTs from the surface of the copper plating film was remarkably observed. The projected ends can be used for emitting field electrons.

### EXAMPLE 7

| | |
|---|---|
| Base Solution 2 + PA25000 | 2 × 10⁻⁴ M |

### EXAMPLE 8

| | |
|---|---|
| Base Solution 2 + PA25000 | 2 × 10⁻⁴ M |
| CNT | 2 g/l |

(Note that, PA25000 was polyacrylic acid, whose molecular weight was 25000)

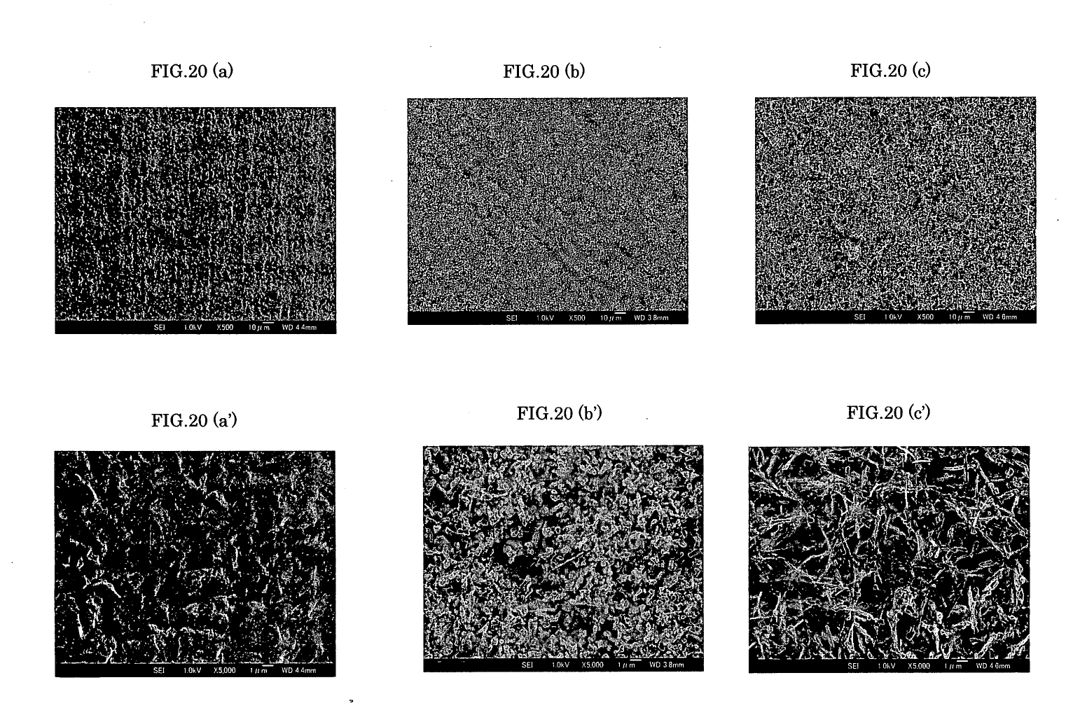

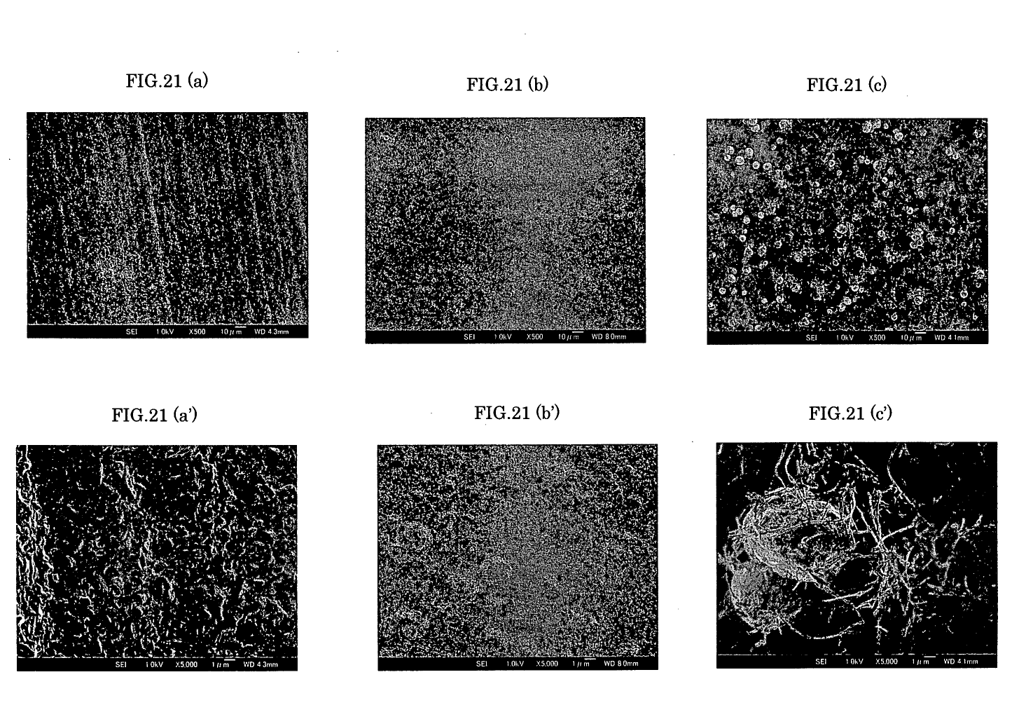

Plating films were respectively formed in the Base Solution 2 and the plating solutions of Examples 7 and 8, which were agitated while plating, by electrolytic plating with current density of 2 A/dm², and micrographs of their surfaces taken by the scanning electron microscope (SEM) are shown in FIGS. 20(a), (a′), FIGS. 20(b), (b′) and FIGS. 20(c), (c′).

As clearly shown in 20(b), (b′) and FIGS. 20(c), (c′), by adding polyacrylic acid, whose molecular weight was 25000, and applying the current density of 2 A/dm², surfaces of the plating films were made rough, so the plating films were useless.

Other plating films were respectively formed in the Base Solution 2 and the plating solutions of Examples 7 and 8, which were agitated while plating, by electrolytic plating with current density of 5 A/dm², and micrographs of their surfaces taken by the scanning electron microscope (SEM) are shown in FIGS. 21(a), (a′), FIGS. 21(b), (b′) and FIGS. 21(c), (c′). FIGS. 22(a) and (b) are enlarged views of FIG. 21(c′), whose rate of enlargement are different. As clearly shown in FIGS. 21(a) and 21(a′), a surface of a copper plating film was relatively rough; as clearly shown in FIGS. 21(b) and 21(b′), flatness of the surface can be improved and a lustered plating film was gained by adding polyacrylic acid and increasing the current density to 5 A/dm². Polyacrylic acid acted as not only the agent for dispersing CNTs but also a brightening agent. As clearly shown in FIGS. 21(c) and 21(c′), the CNTs were incorporated in the nickel plating film. Unlike nickel plating, in copper plating, a plating metal did not grow on surfaces of the CNTs like particles, and copper directly deposited on a substrate as shown in FIG. 22, so that the CNTs were incorporated in the deposited copper plating film and fixed therein. Further, as shown in FIG. 22, projecting ends of the CNTs from the surface of the copper plating film was remarkably observed. The projected ends can be used for emitting field electrons.

### EXAMPLE 9

PA5000 of 2×10⁻⁵ M was added to fine carbon fibers (VGCF: tradename) of 0.2 g/l, and the VGCFs were dispersed in pure water by supersonic waves, then the mixture was filtered with filter paper, further the filtered substances were soaked in a HCl solution of 10 g/l and SnCl₂+10 ml/l for 5 minutes at temperature of 25° C. and further filtered. The filtered substances were treated in a HCl solution of 10 mg/l and PdCl₂+10 ml/l for 5 minutes at temperature of 25° C. and filtered. Further, the filtered substances were electroless-plated for 15 minutes in an electroless nickel plating solution (a pH value was adjusted to nine by adding ammonia) having the following composition at temperature of 35° C.

| | |
|---|---|
| H₂SO₄ | 20 g/l |
| sodium hypophosphite | 20 g/l |
| sodium citrate | 20 g/l |

Micrographs of the VGCFs taken by the scanning electron microscope (SEM) are shown in FIG. 23, which show the fibers not plated (FIG. 23(a)) and those electroless-plated with nickel (FIG. 23(b)). According to the drawings, surfaces of the VGCFs were coated with electroless-plating nickel films.

### EFFECTS OF THE INVENTION

The present invention is capable of providing a plating structure, in which fine carbon fibers or derivatives thereof are incorporated in a plating metal, and a method of producing said plating structure.

1. A plating structure comprising a plating film, in which fine carbon fibers or derivatives thereof are incorporated.

2. The plating structure according to claim 1, wherein said plating film is made of a single metal.

3. The plating structure according to claim 1, wherein said plating film is made of a metal alloy.

4. The plating structure according to claim 1, wherein a resin material is incorporated.

5. The plating structure according to claim 1, wherein said plating film is formed by electrolytic plating.

6. The plating structure according to claim 1, wherein said plating film is formed by electroless plating.

7. The plating structure according to claim 1, wherein ends of the fine carbon fibers project from a surface of said plating film.

8. The plating structure according to claim 1, wherein the derivatives are fluorinated carbon fibers.

9. An electronic part comprising cable patterns having said plating structure according to claim 1.

10. A mechanical part having said plating structure according to claim 1.

11. A multilayer body comprising: some plated layers having said plating structures according to claim 1; and other plated layers being plated with a different metal.

12. A heat radiator comprising: a plurality of plated layers having said plating structures according to claim 1; and a plurality of plated layers being plated with a different metal, wherein two types of said plated layers are alternately layered, and edges of said plated layers plated with the different metal are removed by etching whereby a plurality of said plated layers having said plating structures are arranged parallel with separations.

13. A method of producing a plating structure comprising the steps of: adding a dispersing agent and fine carbon fibers or derivatives thereof into a plating solution so as to disperse the fine carbon fibers or the derivatives in the plating solution; and plating a substrate in the plating solution so as to form a plating film, in which the fine carbon fibers or the derivatives are incorporated, on a surface of the substrate.

14. The method according to claim 13, wherein resin materials are further dispersed in the plating solution so as to form a plating film, in which the resin materials and the fine carbon fibers or the derivatives are incorporated, on the surface of the substrate.

15. The method according to claim 13, wherein a cationic and/or nonionic surfactant is used as the dispersing agent.

16. The method according to claim 13, wherein the dispersing agent is polycarboxylic acid, e.g., polyacrylic acid, or salt thereof.

17. A plating solution including a dispersing agent, which is polycarboxylic acid, e.g., polyacrylic acid, or salt thereof, so as to disperse fine carbon fibers therein.
